(19) United States
(12) Patent Application Publication
(10) Pub. No.: US 2013/0125311 A1
(43) Pub. Date: May 23, 2013

(54) Apparatus for supporting a patient

(71) Applicant: BERCHTOLD HOLDING GMBH, Tuttlingen (DE)

(72) Inventor: Silvio Marugg, Stetten (CH)

(73) Assignee: BERCHTOLD HOLDING GMBH, Tuttlingen (DE)

(21) Appl. No.: 13/656,617

(22) Filed: Oct. 19, 2012

(30) Foreign Application Priority Data
Oct. 20, 2011 (DE) 10 2011 116 524.3

(51) Int. Cl. A61G 13/12

(52) U.S. Cl. CPC A61G 13/1205
USPC 5/621

(57) ABSTRACT

An apparatus for supporting a patient, in particular during an operation, includes a column and a patient support which is supported on the column, wherein the patient support does not have a throughgoing lying surface, but rather comprises a plurality of holders by which the patient can be held and/or fixed at specific anatomically suitable body parts,

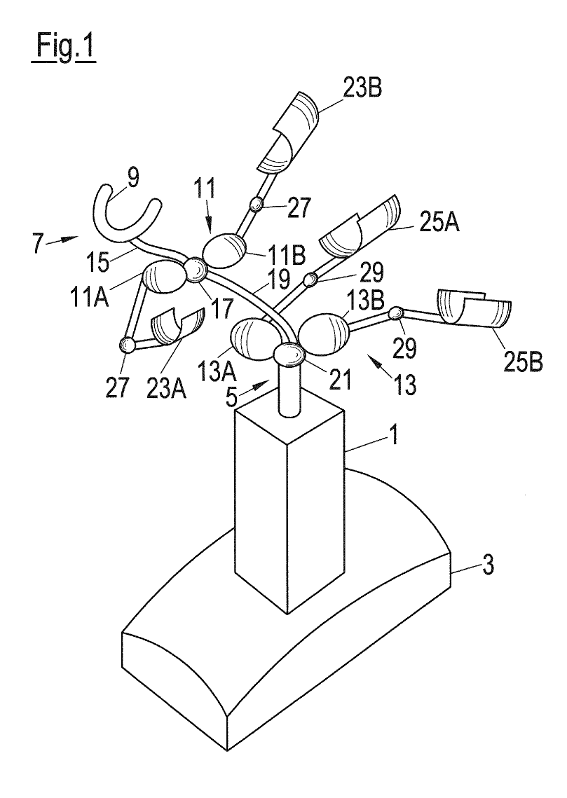

### FIELD

The present invention relates to an apparatus for supporting a patient, in particular during an operation, comprising a column and a patient support which is supported on the column.

### BACKGROUND

Known apparatus for supporting a patient during an operation are operating tables in which the patient support has a throughgoing lying surface on which the patient rests during the operation. Operating tables are also known which have adjustable arm rests and adjustable leg rests in addition to a throughgoing lying surface.

### SUMMARY

It is the underlying object of the present invention to further develop an apparatus of the initially named kind such that a patent can be supported in an improved manner, in particular during an operation.

This object is satisfied by an apparatus for supporting a patient having the features of claim 1 and in particular in that the patient support does not have any throughgoing lying surface, but rather comprises a plurality of holders by which the patient can be held and/or fixed at specific anatomically suitable body positions.

In the apparatus in accordance with the invention, the patient support is thus formed by the holders. A lying surface is no longer provided. Since the holders can be manufactured easily, for example from plastic parts or metal parts, and since the lying surface is omitted, the apparatus in accordance with the invention can be realized comparatively inexpensively. In addition, it can be achieved in a relatively simple construction manner that the holders are adjustable relative to one another so that the patient support can be made adjustable and in particular also adaptable to the patient and to the operation situation. The patient can thus be supported in an improved manner.

The patient is moreover more easily accessible for the surgeon thanks to the lack of a throughgoing lying surface in the apparatus in accordance with the invention. It is, for example, possible by a skilful arrangement of the holders that a location to be operated on is accessible from all sides, whereby the operation can be simplified.

Advantageous embodiments of the invention are described in the description, in the drawing and in the dependent claims.

The holders can be arranged and designed so that they form an exoskeleton. It is in this respect an outer support structure which can surround the patient at least in part. The exoskeleton can thus receive the patient at least in part so that the patient can be securely supported.

In accordance with a preferred embodiment of the invention, one respective holder is formed for holding and/or fixing the patient at a respective one of the body locations. The number of holders can thereby be kept as small as possible since only one holder is provided for each body location to be held and/or to be fixed.

In accordance with a preferred further development of the invention, each holder can at least partly surround the respective body location. The patient can thereby be particularly securely supported.

Preferably, at least one fixing element, preferably flexible, in particular a fixing band, is arranged at each holder for fixing the respective body location. The patient can be strapped tight to the holders by the fixing elements.

In a preferred further development of the invention, a head holder, an upper body holder and a lower body holder are provided. The patient can thereby be held and/or fixed at the particularly important body parts of head, upper body and lower body.

It is in particular advantageous when the patient should be supported lying on his back if the upper body holder has two shoulder holders for holding and/or fixing a respective shoulder of the patient.

The lower body holder preferably has two buttock holders for holding and/or fixing the buttocks of the patient. In particular a patient lying on his back can be held and/or fixed securely in the region of the center of gravity of his body by the buttock holders.

Two arm holders are preferably provided for holding and/or fixing the arms of the patient so that the arms can be supported and can be fixed as required.

At least two leg holders can also be provided for holding and/or fixing the legs of the patient so that the legs can be supported and can be fixed as required.

Each holder preferably has at least one shaped part whose shape is adapted or can be adapted to the respective body location to be held and/or to be fixed. A fixing of the patient to the holder can take place using the shaped part. In this respect, the shaped part can be a vacuum splint or a vacuum mattress.

In accordance with a further preferred embodiment of the invention, the apparatus for supporting a patient has a connection structure via which the holders are connected to one another and which includes a plurality of joints, with the position and/or the alignment of the holders being able to be adjusted by means of the joints. The holders can thus be adjusted relative to one another and can thereby be adapted to the patient to be supported. It can be possible in this respect that a number of different positions compatible for the patient can be set so that the patient can ideally be supported in practically any desired position. A surgeon thus has the possibility of setting the respective ideal position for an operation so that the operation can be performed more easily.

A central clamping mechanism can preferably be provided by means of which the joints can be fixed individually or together in their respective positions.

The apparatus for supporting a patient can have at least one drive by which the holders are adjustable and/or which assists a manual adjustment of the holders. The drive can be coupled to the joint, for example. Provision can also be made that each joint is coupled to its own drive, in particular to a servo motor, by means of which the respective joint is adjustable or which assists a manual adjustment of the respective joint.

A control is preferably provided which is coupled to the at least one drive and by means of which an adjustment of the holders can be controlled.

In a preferred embodiment of the invention, at least one bearing is arranged between the column and the patient support by which the patient support can be adjusted relative to the column. The joint can be designed so that the patient support can be adjusted both about a longitudinal axis (also called tilt) and along a transverse axis (also called trend) and can be rotated about a vertical axis of rotation with respect to the column.

A restraint can also be provided which can receive at least one of the body locations to be held and/or to be fixed, with the restraint having at least one chamber which is filled with a material which can be reversibly brought from a liquid state or from a gaseous state into a solid state for holding and/or fixing the body location. The restraint can be “put onto” the patient—when the material is present in the liquid or gaseous state and the body location can be fixed in that the material is brought into the solid state. In this respect, the restraint can be fastenable at least to one holder.

### DRAWING

The present invention will be described purely by way of example in the following with reference to the enclosed sole drawing in which an apparatus in accordance with the invention for supporting a patient is shown schematically in a perspective view.

### DETAILED DESCRIPTION

The apparatus shown for supporting a patient includes a column 3 which stands on a base 3 and which is connected via a bearing 5 to a patent support 7 supported on the column 1. In this respect, the patient support 7 has a plurality of holders on which the patient can be placed and can be held and fixed at specific anatomically particularly suitable body locations during an operation.

One of the holders is a head holder 9 with which the head of the patient can be held and fixed. In addition, an upper body holder 11 is provided which includes two shoulder holders 11A, 11B which can hold and fix the shoulders of the patient. A lower body holder 13 has two buttock holders 13A, 13B for holding and fixing the buttocks of the patient. In addition, two arm holders 23A, 23B and two containers 25A, 25B are provided.

The holders 9, 11A, 11B, 13A, 13B, 23A, 23B, 25A and 25B forming the patient support 7 are formed as supports for the respective body locations to be held. At least one fixing band, not shown, is provided at each holder 9, 11A, 11B, 13A, 13B, 23A, 23B, 25A and 25B and can be clamped around the respective body part to fix it to the respective holder.

The head holder 9, the should holders 11A, 11B and the buttock holders 13A, 13B are connected to one another via a connection structure. The connection structure includes a first connection bar 15 and a first multiple joint 17 via which the two shoulder holders 11A, 11B are connected to the head holder 9. The connection structure additionally includes a further, second connection bar 19 and a further, second multiple joint 21. In this respect, the two multiple joints 17, 21 are connected to one another via the second connection bar 19 and the buttock holders 13A, 13B are pivotally connected to the second multiple joint 21.

In addition, a respective arm holder 22A, 23B is connected to a respective shoulder holder 23A, 23B via an arm joint 27. A respective leg holder 25A, 25B is connected via an arm joint 29 to a respective buttock holder 13A, 13B.

The holders 9, 11A, 11B, 13A, 13B, 23A, 23B, 25A and 25B are adjustable relative to one another via the joints 17, 21, 27 and 29 so that the patient can be supported in practically any desired position. A servo motor, not shown, which is controllable via a control, not shown, can be integrated into each joint 17, 21, 27, 29. The joints 17, 21, 27, 29 and thus the holders 9, 11A, 11B, 13A, 13B, 23A, 23B, 25A and 25B can thereby be fully automatically adjusted. Alternatively, the servo motors can be designed to accompany a manual adjustment of the joints 17, 21, 27, 29 and of the holders 9, 11A, 11B, 13A, 13B, 23A, 23B, 25A and 25B with force assistance.

The second multiple joint 21 is connected to the joint 5 via which the column 1 and the patient support 7 are connected to one another. Both the trend and the tilt of the patient support 7 can be varied by the joint 5. In addition, the patient support 7 can thereby be rotated about a vertically extending axis about the column 1.

The apparatus shown is provided for supporting a patient lying on his back. In another embodiment in accordance with the invention, not shown, the holders which form the patient support can be designed to support the patient lying on his stomach. As the essential difference from the apparatus shown, at least one chest holder is provided instead of the shoulder holders 11A, 11B and at least one stomach holder instead of the buttock holders 13A, 13B.

### REFERENCE NUMERAL LIST

1 column

3 base

5 bearing

7 patient support

9 head holder

11 upper body holder

11A shoulder holder

11B shoulder holder

13 lower body holder

13A buttock holder

13B buttock holder

15 connection bar

17 joint

19 connection bar

21 joint

23A arm holder

23B arm holder

25A leg holder

25B leg holder

27 arm joint

29 leg joint

1. An apparatus for supporting a patient comprising a column (1) and a patient support (7) which is supported on the column (1),
wherein the patient support (7) does not have a throughgoing lying surface, but rather comprises a plurality of holders (9, 11, 13, 23A, 23B, 25A, 25B) by which the patient can be held and/or fixed at specific anatomically suitable body locations.

2. An apparatus in accordance with claim 1,
wherein the holders (9, 11, 13, 23A, 23B, 25A, 25B) are arranged and designed such that they form an exoskeleton.

3. An apparatus in accordance with claim 1,
wherein a respective holder (9, 11, 13, 23A, 23B, 25A, 25B) is formed at a respective one of the body locations for holding and/or fixing the patient.

4. An apparatus in accordance with claim 1,
wherein each holder (9, 11, 13, 23A, 23B, 25A, 25B) can at least partly surround the respective body location and/or at least one fixing element is arranged at each holder (9, 11, 13, 23A, 23B, 25A, 25B) for fixing the respective body location.

5. An apparatus in accordance with claim 1,
wherein a head holder (9), an upper body holder (11) and a lower body holder (13) are provided.

6. An apparatus in accordance with claim 5,
wherein the upper body holder (11) has two shoulder holders (11A, 11B) for holding and/or fixing a respective one shoulder of the patient.

7. An apparatus in accordance with claim 5,
wherein the lower body holder (13) has two buttock holders (13A, 13B) for holding and/or fixing the buttocks of the patient.

8. An apparatus in accordance with claim 1,
wherein at least two arm holders (23A, 23B) are provided for holding and/or fixing the arms of the patient.

9. An apparatus in accordance with claim 1,
wherein at least two leg holders (25A, 25B) are provided for holding and/or fixing the legs of the patient.

10. An apparatus in accordance with claim 1,
wherein each holder (9, 11, 13, 23A, 23B, 25A, 25B) has at least one shaped part whose shape is adapted or can be adapted to the respective body location to be held and/or to be fixed.

11. An apparatus in accordance with claim 1,
wherein a connection structure (15, 19) is provided via which the holders (9, 11, 13, 23A, 23B, 25A, 25B) are connected to one another and which includes a plurality of joints (17, 21, 27, 29), with the position and/or the alignment of the holders (9, 11, 13, 23A, 23B, 25A, 25B) being able to be adjusted by means of the joints (17, 21, 27, 29).

12. An apparatus in accordance with claim 11,
wherein the holders (9, 11, 13, 23A, 23B, 25A, 25B) are adjustable relative to one another by the joints (17, 21, 27, 29) such that a plurality of different patient-compatible positions can be set.

13. An apparatus in accordance with claim 11,
wherein a central clamping mechanism is provided by means of which the joints (17, 21, 27, 29) can be fixed individually or together in their respective positions.

14. An apparatus in accordance with claim 1,
wherein at least one drive is provided by which the holders (9, 11, 13, 23A, 23B, 25A, 25B) are adjustable and/or which assists a manual adjustment of the holders (9, 11, 13, 23A, 23B, 25A, 25B).

15. An apparatus in accordance with claim 14,
wherein a control is provided which is coupled to the at least one drive and by means of which an adjustment of the holders (9, 11, 13, 23A, 23B, 25A, 25B) can be controlled.

16. An apparatus in accordance with claim 1,
wherein at least one bearing (5) is arranged between the column (1) and the patient support (7) by which the patient support (7) is adjustable relative to the column (1).

17. An apparatus in accordance with claim 1,
wherein a restraint is provided which can take up at least one of the body parts to be held and/or to be fixed.

18. An apparatus in accordance with claim 17,
wherein the restraint includes at least one chamber which is filled with a material which can be reversibly brought from a liquid state or from a gaseous state into a solid state for holding and/or fixing the body location.

19. An apparatus for supporting a patient comprising a column (1) and a patient support (7) which is supported on the column (1),
wherein the patient support (7) does not have a throughgoing lying surface, but rather comprises a plurality of holders (9, 11, 13, 23A, 23B, 25A, 25B) by which the patient can be held and/or fixed at specific anatomically suitable body parts, wherein a connection structure (15, 19) is provided via which the holders (9, 11, 13, 23A, 23B, 25A, 25B) are connected to one another and which includes a plurality of joints (17, 21, 27, 29), wherein the position and/or the alignment of the holders (9, 11, 13, 23A, 23B, 25A, 25B) can be adjusted by means of the joints (17, 21, 27, 29), and wherein a central clamping mechanism is provided by means of which the joints (17, 21, 27, 29) can be fixed individually or together in their respective positions.

20. An apparatus for supporting a patient comprising a column (1) and a patient support (7) which is supported on the column (1),
wherein the patient support (7) does not have a throughgoing lying surface, but rather comprises a plurality of holders (9, 11, 13, 23A, 23B, 25A, 25B) by which the patient can be held and/or fixed at specific anatomically suitable body parts, and wherein a restraint is provided which can receive at least one of the body parts to be held and/or fixed.
